(19) United States
(12) Patent Application Publication
(10) Pub. No.: US 2010/0015275 A1
(43) Pub. Date: Jan. 21, 2010

(54) INJECTION-MOLDING NOZZLE

(76) Inventor: Herbert Günther, Allendorf (DE)

Correspondence Address: CLARK & BRODY, 1090 VERMONT AVENUE, NW, SUITE 250, WASHINGTON, DC, 20005, US

(21) Appl. No.: 12/449,579

(22) PCT Filed: Jan. 21, 2008
(86) PCT No.: PCT/EP2008/000403

§ 371 Date: Aug. 14, 2009

(30) Foreign Application Priority Data
Feb. 23, 2007 (DE) 20 2007 002 817.2

(51) Int. Cl. B29C 45/23; B29C 45/20

(52) U.S. Cl. 425/564; 425/542

(57) ABSTRACT

The invention relates to an injection-molding equipment nozzle (10; 80) comprising a nozzle casing (14) wherein is subtended at least one flow duct (20) for a flowable feed material, further a nozzle mouth (24; 84) which extends the flow duct and is mounted on the nozzle casing (14), said nozzle mouth subtending a discharge aperture for said flowable feed material, further flow-enhancing elements (60; 88) running through the flow duct (20) being integrated into the nozzle mouth (24; 84) to thoroughly mix the flowable feed material.

The present invention relates to an injection-molding nozzle for injection-molding equipment defined in the preamble of claim 1.

Injection molding nozzles are used in injection molds to feed a flowable feed material at a predetermined temperature and high pressure to a separable mold block respectively mold insert. Mostly the casings of such nozzles are in the form of material feeding pipe subtending a flowable feed-material flow duct and fitted at one end with an inserted nozzle mouth constituting the flow ducts discharge aperture.

To preclude striations from forming in workpieces being manufactured, for instance due to insufficiently mixing/homogenizing the flowable feed material prior to its injection, the state of the art has proposed a number of remedial steps.

WO-A-2003/035358 for instance discloses an injection mold fitted with a mixer in its flow duct. This mixer enhances the homogeneity of the flowable feed material which is mixed and of which the helical flow is converted into an annular one. This step is implemented using a plurality of components configured in said flow duct, namely a first muff comprising a helical groove, a second muff with a helical groove, a so-called torpedo configured coaxially with said muffs, a ring configured between these muffs and at least one spoked wheel projecting radially from a surface of said longitudinal torpedo and subtending a predetermined angle to said torpedo's longitudinal axis and connected to said ring. The manufacture of the mixer, its installation and the entailed costs entail drawbacks, in particular the number of individual mixer components.

The patent document WO-A-2001/034365 describes an injection-molding nozzle mixer fitted with flowable feed material flow duct open in the downward direction and comprising an elongated element inserted in said duct and entering by its tip a pre-chamber while fitted with a helical groove in the outer flow duct surface, this groove aperture pointing inward toward the elongated element. The groove is subtended between two ridges of which the clear inside separation flares toward the pre-chamber, as a result of which a helical flow of feed materialist created by said helical groove while an axial flow of melt is made possible above the ridges. This design allows thoroughly mixing the flowable feed material. Alternatively the helical groove may be fitted into a separate muff inserted from below into the flow duct. Again the mixer is composed of a plurality of components, namely the said elongated element and the helical groove in the flow duct's outer surface or alternatively the elongated element and the helical muff fitted with the helical groove.

In the light of the above state of the art, one objective of the present invention is to create an alternative injection-molding equipment nozzle assuring in simple manner good mixing of the flowable feed material passing through the flow duct, in particular when employing a lesser number of components.

This problem is solved by the present invention by an injection-molding nozzle defined in claim 1. The dependent claims relate to particular designs of the present invention.

The present invention creates an injection-molding nozzle with a nozzle casing subtending in it at least one flow duct for a flowable feed material and a nozzle mouth which is mounted on said casing and extends the said flow duct and constitutes a discharge aperture for said flowable feed material. In the design of the present invention, flow-enhancing elements running through the flow duct are integrated into the nozzle mouth to mix the flowable feed material. Accordingly, in the present invention, the basic mixing principle applied to its injection-molding nozzle is not the minimum of at least partial helical deflection of the feed material passing through the flow duct used in the above cited state of the art, instead it is to the swirl the flow of feed material impacting the integrated flow-enhancing elements, attaining thereby moreover the desired feed material homogenization. The injection-molding nozzle of the present invention also offers one considerable advantage in that the nozzle mouth is designed in a manner tot assume all mixer functions. In advantageous manner with respect to manufacturing and assembly, this embodiment requires no additional component for the mixer.

In a preferred embodiment mode of the present invention, the said integrated flow-enhancing elements are at least partly in the form of bars or the like, as a result of which the feed material passing through the flow duct shall be irreversibly fractured, mixed and/or deflected.

The present invention moreover provides that the flow-enhancing elements subtend between them mutually crossing flow sub-ducts or passages for the flowable material. This feature assures especially intensive mixing/homogenizing so that striations in the workpiece shall be precluded.

Moreover the bar-shaped flow-enhancing elements preferably at least in part subtend between them angles, the corresponding angle apices pointing in a direction which is the direction of feed material flow and/or that opposite it. In this manner the flow of feed material may be advantageously comminuted and swirled.

Where a valve-needle fitted injection-molding nozzle is used, a passage aperture passing a valve needle shall be designed in a further embodiment mode of the present invention in the mouth element. This mouth is advantageously fitted with at least one intake cone to center the valve needle before said needle's sealing edge makes contact with its sealing seat. In this manner the sealing edge is reliably guided in centered manner into its seat, whereby damaging said edge and said seat is precluded, such damages arising otherwise when the needle is centered by its sealing edge being inserted into the seat.

Illustrative embodiment modes of the injection-molding nozzle of the present invention are elucidated below in relation to the appended drawings.

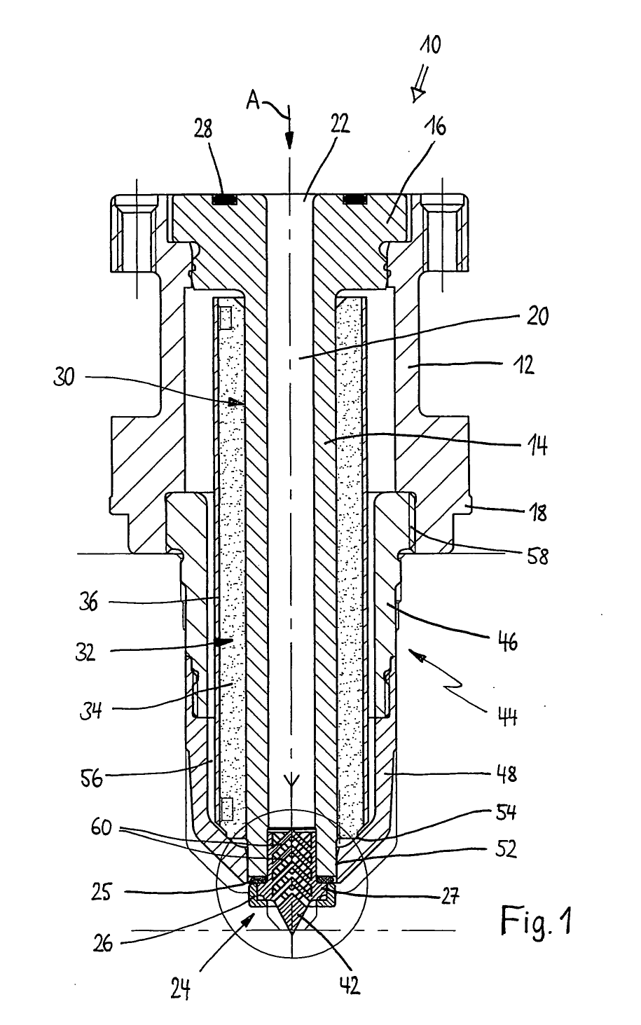

FIG. 1 is a cross-sectional elevation of a first embodiment mode of an injection-molding nozzle of the invention,

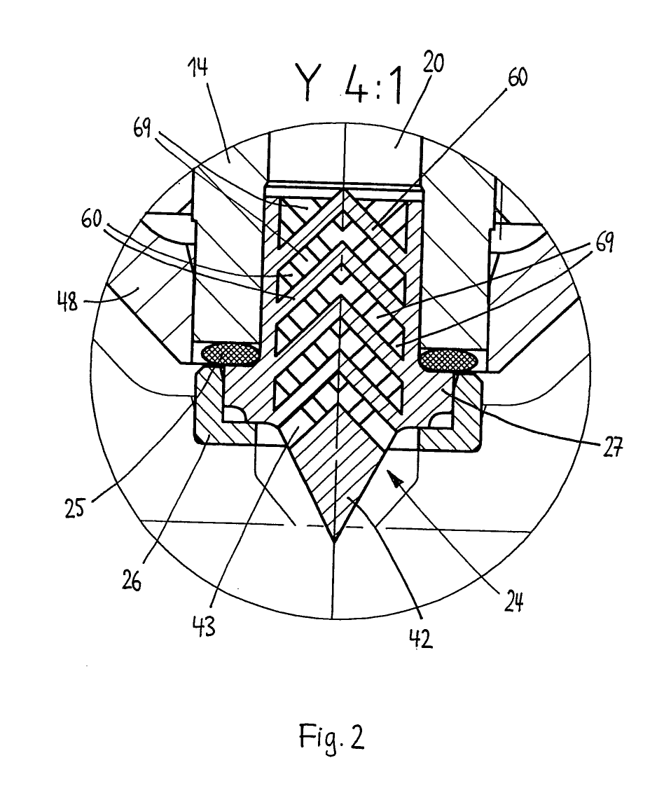

FIG. 2 is an enlarged portion for the region denoted by a circle in FIG. 1,

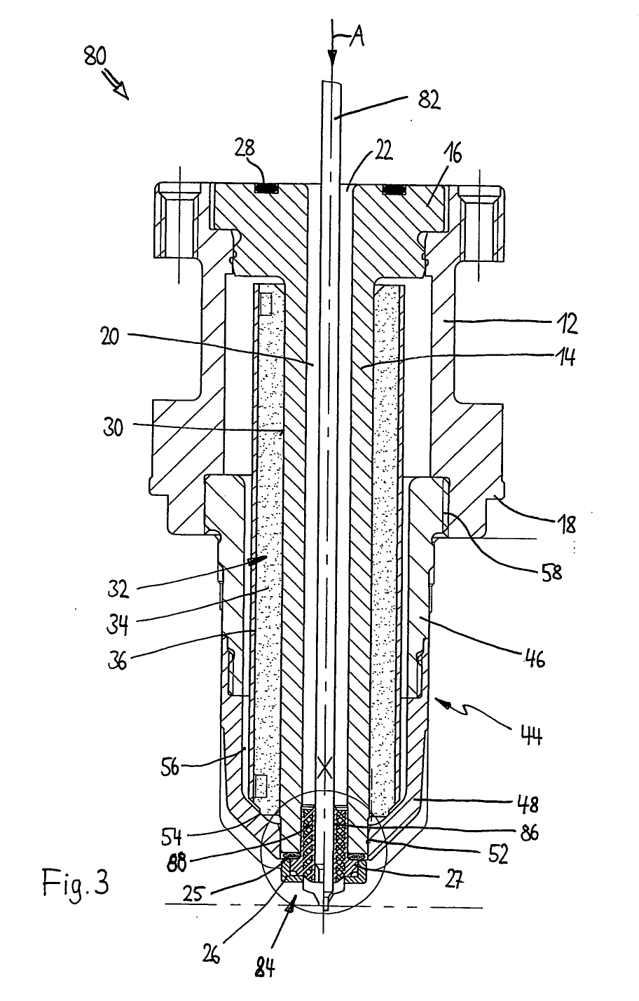

FIG. 3 is a cross-sectional elevation of a second embodiment mode of an injection-molding nozzle of the invention, and

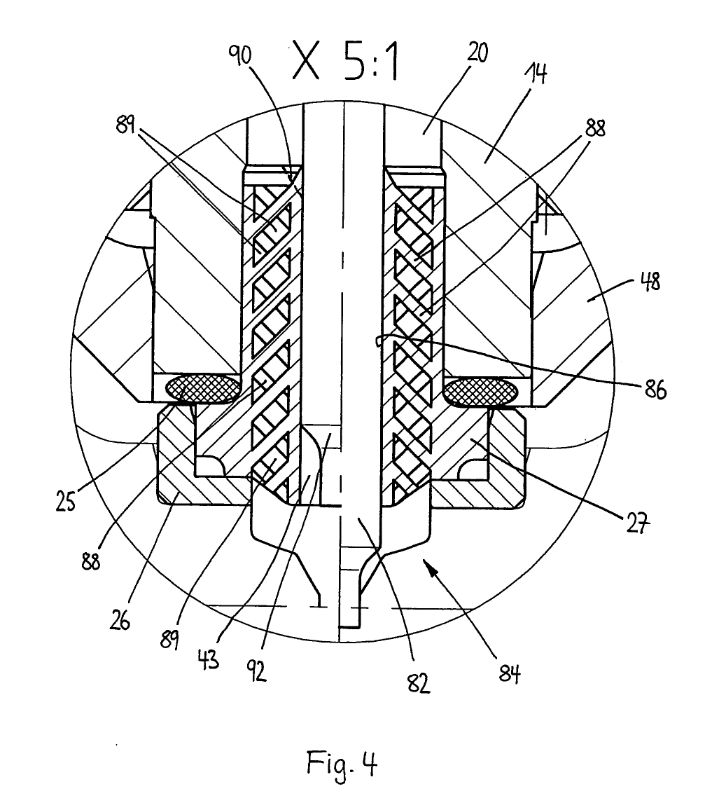

FIG. 4 is an enlarged portion of the region of FIG. 3 denoted by a circle.

In FIG. 1 a first embodiment mode of an injection-molding nozzle is denoted overall by the reference 10. This nozzle is used in injection molding equipment making molded parts from a flowable feed material—for instance a melt of plastic. The omitted injection molding equipment typically includes a mounting plate running parallel to a manifold plate comprising a system of flow ducts. These ducts issue into several injection-molding nozzles 10 for instance in the form of hot runner nozzles each mounted by a housing 12 to the underside of the manifold plate.

Each injection-molding nozzle 10 comprises a nozzle casing 14 fitted at its upper end with a flange-like hookup head 16. Said head is detachably seated in the housing 12. A radial boss 18 centers the housing 12 and hence the injection-molding nozzle 10 within the injection molding equipment.

A flow duct 20 transmitting the melt of feed material is centrally configured within the nozzle casing 14 which runs in the axial direction A. This flow duct 20 preferably is in the form of a borehole and comprises a material feed aperture 22 in the hookup head 16, and, at its lower end, it issues into a nozzle mouth 24 subtending a nozzle tip 42. Said tip comprises at least one feed-material discharge aperture 43 to allow the flowable melt to reach an omitted molding nest of the injection molding equipment.

The nozzle mouth 24 illustratively is highly thermally conducting, and, as elucidated by FIG. 2, is inserted into the material feed pipe 14 with interposition of a sealing ring 25 while being kept displaceable in the axial direction A in a manner that both the nozzle casing 14 and the nozzle mouth 24 per se are able to expand respectively move in the axial direction while the injection-molding nozzle 10 is raised to the operating temperature. When said temperature is reached, a tight seating of the nozzle mouth 24 between a supporting and centering element 26 and the sealing ring shall be attained. The supporting and centering element 26 illustratively is muff-like. It encloses in geometrically and/or frictionally locking manner the nozzle mouth 24—which is terminally fitted with a flange-like extension 27—and enters in centering and sealing manner a matching seat in the mold nest (not shown in detail).

It is clear from FIG. 2 that the nozzle mouth 24 rests by the flange 27 and by means of the seal 25 against the lower end of the nozzle casing 14. However the nozzle mouth 24 also may be designed to be devoid of a flange extension 27. In the latter case the nozzle mouth 24 illustratively rests against the inside of the nozzle casing 14, for instance against an offset configured there.

Depending on application, the nozzle mouth 24 also may be terminally screwed into the feed pipe 14.

A sealing ring 28 concentric with the material feed aperture 22 is configured in the hookup head 16 of the material feed pipe 14 to seal the injection-molding nozzle 10 from the manifold plate. Moreover an additional annular centering offset may be employed to facilitate mounting the injection-molding nozzle 10 on the said injection molding equipment.

A heater 32 is deposited on the external circumference 30 of the material feed pipe 14. This heater is designed as a thermally well conducting muff 34 for instance made of copper or brass running almost over the full axial length of the material feed pipe 14. An electrical heating coil (not shown) is configured in the (unreferenced) wall of the muff and runs parallel to the flow duct 20, the coil terminals (not shown) being outside the housing 12. The heater 32 as a whole is enclosed by a tubular sheath 36.

A temperature sensor (not shown) may be used to detect the temperature generated by the heater 32.

To thermally screen both the material feed pipe 14 and the heater 32 from the mold plates, the housing 12 is extended in the direction of the nozzle tip 42 by a shank 44. This shank comprises a hardened-steel main part 46 and a capping end part 48 of the thermally poorly conducting material. Said capping end part subtends a seat 52 fitted with a substantially inner cylindrical contour which encloses in sealing manner the free end of the material feed pipe 14 in the slip-in seat while the shank main part 46 encloses the material feed pipe 14 at a radial distance from it, as a result of which, except for a small resting spot 54 of the heater 32, a thermally insulating air gap 56 remains at the tend part 48 between the heater 32 and the shank 44.

The generally cylindrical shank main part 46 is fitted at its upper end with an external thread 58 by means of which it is screwed from below into the housing 12. The lower end of the main shank part 46 is stepped and soldered onto the upper end of the terminal part 48.

The nozzle mouth 24 comprises integrated, bar-like flow-enhancing elements 60 running radially and axially through the flow duct. These flow-enhancing elements 60 swirl the flow of feed material through the flow duct 20 to improve its homogeneity. For that purpose they are configured into a plurality of intercrossing sub-ducts or passages 69 continuously deflecting, mixing and finally conveying the said feed material to its discharge aperture 43 communicating with the omitted molding nest.

This design reliably precludes forming striations and the like in the workpiece being manufactured. In the shown embodiment mode, the shape of the flow-enhancing elements 60 is selected in a way that two bar-like flow-enhancing elements are connected to each other to subtend an angle, the angle apices subtended by the associated angles alternatingly pointing in the direction of flow and opposite it of the flowable feed material passing through the flow duct 20. Feed material mixing advantageous to flowing is attained commensurately.

The nozzle mouth 24 illustratively may be manufactured by electric spark machining, rapid prototyping, laser cusing respectively laser sintering or the like.

When the injection-molding nozzle 10 is in operation, the heat generated by the heater 32 is transmitted to the material feed pipe 14 and hence to the melt flowing through it. The pitch of the heating coil segments configured in the axial direction A may be selected to be different, as a result of which different amounts of heat are delivered to the corresponding axial material feed pipe segments to apply differential amounts of heat to the corresponding said axial segments, that is, the heating varies along these segments. Once the melt reaches the nozzle mouth 24, it is made to swirl upon impacting the flow-enhancing elements 60 and homogenized in this manner before passing through the discharge aperture and being fed to the mold.

FIGS. 3 and 4 show another embodiment mode of an injection-molding nozzle 80 of the present invention, FIG. 3 being a cross-sectional view of the nozzle 80 and FIG. 4 being an enlarged detail of FIG. 3 indicated by a circle. The design of the injection-molding nozzle 80 includes a valve needle 82 in a manner that the structure of the nozzle 84 differs from that of the nozzle 24 shown in FIGS. 1 and 2. Otherwise the designs of the nozzles 80 and 10 are congruent and therefore need not be discussed again.

The nozzle mouth 84 comprises a passage aperture 86 running in the axial direction A and passing the valve needle 82. Similarly to the case of the nozzle mouth 24 of the first embodiment mode of the injection-molding nozzle 10, the nozzle mouth 84 of the said nozzle 80 also is fitted with flow-enhancing elements 88 which are integral with the nozzle 84 and which run transversely to the axial direction A at an angle of about 45° in the upstream and downstream directions to mix respectively homogenize said passing melt. In this manner again intercrossing flow sub-ducts or passages 89 are subtended between the flow-enhancing elements 88 to assure everywhere intensive mixing of the flowing feed material that thereby is moved toward the feed material discharge aperture 43.

As shown especially clearly in FIG. 4, the upstream pointing end of the nozzle mouth 84 may be fitted at the passage aperture 86 with a conical widening as a result of which an intake cone 90 is subtended to center the valve needle 82 during its excursion into the nozzle mouth 84. As the valve needle 82 enters the nozzle mouth 84, it is centered by the coordinated actions of its circumferential edge 92 and the intake cone 90, preventing thereby impacting the sealing edge of the valve needle 62 when being guided into the pertinent sealing seat, hence precluding an otherwise entailed wear of the sealing edge respectively the sealing seat, though this precautionary feature is not elucidated in the appended Figures. Alternatively the excursion of the valve needle 82 also may be selected in a manner that this needle and the nozzle mouth 84 shall be permanently engaging each other. In this latter case the intake cone 90—as shown in FIG. 4—may be minimized or eliminated entirely.

As in the case of the first embodiment mode, the nozzle mouth 84 may be made by spark cutting, rapid prototyping, laser cusing respectively laser sintering or the like. Again, the affixation of the nozzle mouth 84 to the nozzle casing 14 of the injection-molding nozzle 84 may be implemented in a manner equivalent to that of the first embodiment mode.

The present invention is not restricted to one of the two above described embodiment modes, but instead may be modified in many ways. Illustratively the heater also may be directly applied in the form of a thick film heater on the material feed pipe respectively on the nozzle casing 14. Also a heater may be replaced by a cooling system. In the latter case the nozzle 10 would be designed as a cold runner nozzle. Moreover the nozzle mouth 24 may be made of a high-strength material whereby abrasive and/or corrosive media might be processed.

All features and advantages implicit in and explicit from the claims, the specification and the drawings, inclusive design details, spatial configurations and procedural steps, may be construed being inventive per se and also in arbitrary combinations.

### LIST OF REFERENCES

10 injection molding nozzle
12 housing
14 nozzle casing/material feed pipe
16 hookup head
18 step
20 flow duct
22 material feed aperture
24 nozzle mouth
25 sealing ring
26 support
27 widening
28 sealing ring
30 external surface/circumference
32 heater
34 muff
36 tubular sheath
42 nozzle tip
43 feed material discharge aperture
44 shank
46 main shank part
48 end part
52 seat
54 rest site
56 air gap
58 external thread
60 flow-enhancing elements
69 flow duct/passage
80 injection molding nozzle
82 valve needle
84 nozzle mouth
86 passage aperture
88 flow-enhancing elements
89 flow duct/passage
90 intake cone
82 circumferential edge

1. An injection-molding nozzle (10; 80) for injection molding equipment and comprising a nozzle casing (14) containing at least one flow duct (20) for a flowable feed material and a nozzle mouth (24; 84) which is affixed to said casing, extends said flow duct and is fitted with discharge aperture for the flowable feed material,
characterized in that
flow-enhancing elements (60; 88) running through the flow duct (20) are integrated into the nozzle mouth (24;84) to thoroughly mix the flowable feed material.

2. Injection molding nozzle (10; 80) as claimed in claim 1, characterized in that the integrated flow-enhancing elements (60; 88) are at least in part bar-like.

3. Injection molding nozzle (10; 80) as claimed in claim 1, characterized in that the integrated flow-enhancing elements (60; 88) subtend inter-crossing flow sub-ducts or passages (69; 89).

4. Injection molding nozzles as claimed in claim 2, characterized in that the integrated, bar-like flow-enhancing elements (60) at least partly subtend an angle between them.

5. Injection molding nozzle (10; 80) as claimed in claim 4, characterized in that the subtended angle apices of the integrated, bar-like flow-enhancing elements (60) point in a direction which is that of the flow and/or opposite the direction of flow of the flowable feed material passing through the flow duct (20).

6. Injection molding nozzle (80) as claimed in claim 1, characterized in that a passage aperture (86) to pass a valve needle (82) is constituted in the nozzle mouth (84).

7. Injection molding nozzle (80) as claimed in claim 6, characterized in that the nozzle mouth (84) is fitted with at least one intake cone (90) to center the valve needle (82).
